(19) United States
(12) Patent Application Publication
(10) Pub. No.: US 2022/0139376 A1
(43) Pub. Date: May 5, 2022

(54) PERSONAL SPEECH RECOMMENDATIONS USING AUDIENCE FEEDBACK

(71) Applicant: International Business Machines Corporation, Armonk, NY (US)

(72) Inventors: Beat Buesser, Ashtown (IE); Bei Chen, Blanchardstown (IE); Yufang Hou, Dublin (IE); Akihiro Kishimoto, Setagaya (JP)

(21) Appl. No.: 17/087,541

(22) Filed: Nov. 2, 2020

(51) Int. Cl. G10L 15/08; G10L 15/22; G10L 15/26; H04L 67/01

(52) U.S. Cl. CPC G10L 15/08; H04L 67/42; G10L 15/26; G10L 15/22

(57) ABSTRACT

Aspects of the present invention disclose a method for generating speech recommendations for a user based on feedback data corresponding to a plurality of viewers of the user. The method includes one or more processors identifying speech of a user in audio data of the user. The method further includes identifying feedback of one or more audience members of the user associated with the speech of the user. The method further includes generating an assessment of the speech of the user, wherein the assessment is based at least in part on the feedback of the one or more audience members. The method further includes generating a speech recommendation for the speech of the user based at least in part on the assessment of the speech.

### BACKGROUND OF THE INVENTION

The present invention relates generally to the field of artificial intelligence, and more particularly to providing speech feedback to a user.

In recent years, there has been an increase in demand to utilize the advanced techniques for analyzing large and/or complex data sets. In particular, natural language processing (NLP), which is a sub-field of computer science that enables a computer to process and analyze large amounts of natural language data. Sentiment analysis utilizes NLP, computational linguistics, and text analysis to extract and analyze subjective information. A basic task in sentiment analysis is classifying the polarity of a given text where an expressed opinion of the given text is positive, negative, or neutral. Advanced sentiment classification techniques are able to determine an expressive tone of a given text as well.

Cognitive analytics combines the use of cognitive computing and analytics. Cognitive computing combines artificial intelligence and machine-learning algorithms, in an approach that attempts to reproduce the behavior of the human brain. Analytics is the scientific process of transforming data into insights for making better decisions. Cognitive analytics applies intelligent technologies to bring unstructured data sources within reach of analytics processes for improved and informed decision making.

Machine learning is the scientific study of algorithms and statistical models that computer systems use to perform a specific task without using explicit instructions, relying on patterns and inference instead. Machine learning is seen as a subset of artificial intelligence. Machine learning algorithms build a mathematical model based on sample data, known as “training data,” in order to make predictions or decisions without being explicitly programmed to perform the task. Machine learning algorithms are used in a wide variety of applications.

### SUMMARY

Aspects of the present invention disclose a method, computer program product, and system for generating speech recommendations for a user based on feedback data corresponding to a plurality of viewers of the user. The method includes one or more processors identifying speech of a user in audio data of the user. The method further includes one or more processors identifying feedback of one or more audience members of the user associated with the speech of the user. The method further includes one or more processors generating an assessment of the speech of the user, wherein the assessment is based at least in part on the feedback of the one or more audience members. The method further includes generating one or more processors a speech recommendation for the speech of the user based at least in part on the assessment of the speech.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for generating speech recommendations for a user based on feedback data corresponding to a plurality of viewers of the user, in accordance with embodiments of the present invention.

FIG. 3 is a block diagram of components of FIG. 1, in accordance with an embodiment of the present invention.

### DETAILED DESCRIPTION

Embodiments of the present invention allow for generating speech recommendation for a user based on data corresponding to a plurality of viewers of the user. Embodiments of the present invention rates a performance of a speech of a user based on multimedia data of the user. Additional embodiments of the present invention identify properties and conditions of the audience utilizing image, video, and audio data. Embodiments of the present invention generate one or more speech recommendations to a user in real or near-real-time based on properties and conditions of the audience.

Some embodiments of the present invention recognize that challenges exist with providing real-time feedback from a plurality of viewers of a user with respect to a speech of the user. For example, a presenter is giving a speech as it relates to a presentation and the presenter needs to update the speech based on properties and/or conditions of the viewers (e.g., facial expressions, inquiries, activities, etc.). Embodiments of the present invention generate speech recommendations based on the properties and/or conditions of the viewers, which enables the presenter to improve the speech of the presentation. For example, improvements of speech may include but is not limited to conveying a message of a speech more effectively, increasing viewer engagement based on viewer reactions, or increasing presenter confidence.

Embodiments of the present invention can operate to improve teleconferencing systems by providing a dynamic real-time speech feedback feature based on viewers. Additionally, various embodiments of the present invention improve the efficiency of network resources by reducing the amount of data the network has to transmit as a result of less data being transmitted due to questions eliminated by speech recommendations and extensions of teleconferencing sessions.

Implementation of embodiments of the invention may take a variety of forms, and exemplary implementation details are discussed subsequently with reference to the Figures.

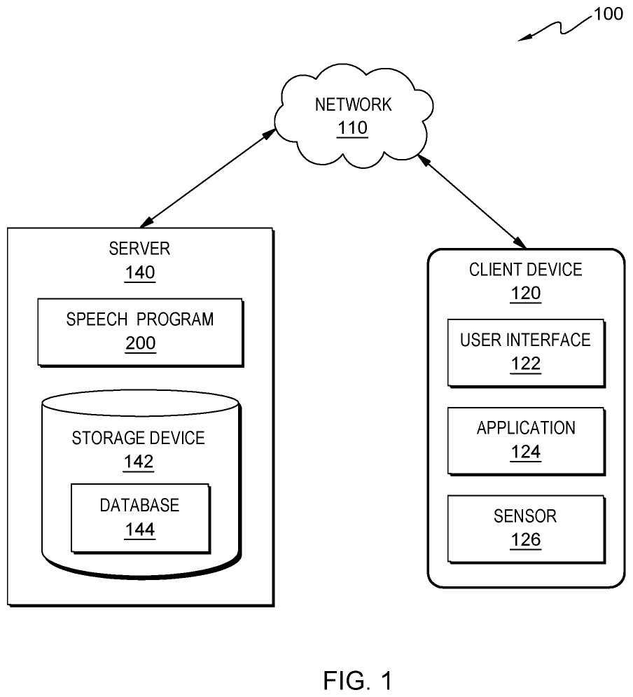

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The present invention may contain various accessible data sources, such as database 144, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Speech program 200 enables the authorized and secure processing of personal data. Speech program 200 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Speech program 200 provides information regarding personal data and the nature (e.g., type, scope, purpose, duration, etc.) of the processing. Speech program 200 provides the user with copies of stored personal data. Speech program 200 allows the correction or completion of incorrect or incomplete personal data. Speech program 200 allows the immediate deletion of personal data.

Distributed data processing environment 100 includes server 140 and client device 120, all interconnected over network 110. Network 110 can be, for example, a telecommunications network, a local area network (LAN) a municipal area network (MAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 140 and client device 120, and other computing devices (not shown) within distributed data processing environment 100.

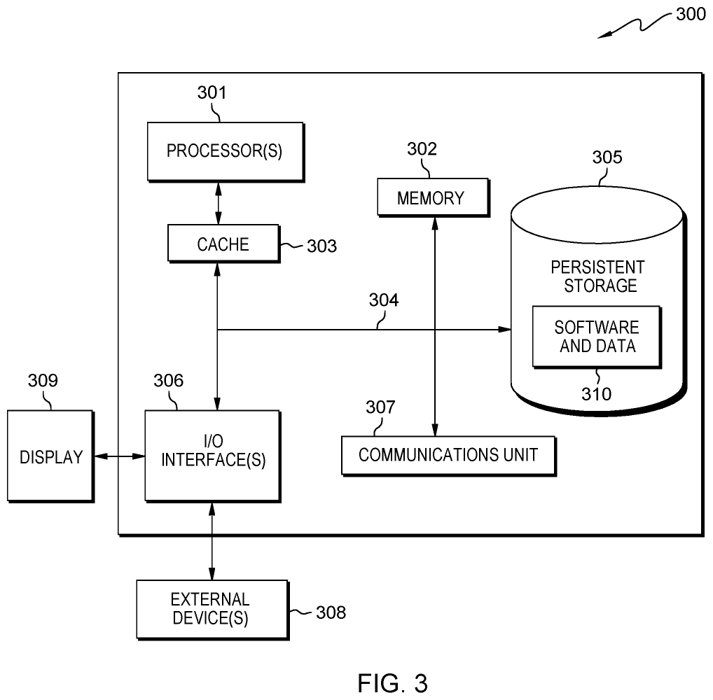

Client device 120 can be one or more of a laptop computer, a tablet computer, a smart phone, smart watch, a smart speaker, virtual assistant, or any programmable electronic device capable of communicating with various components and devices within distributed data processing environment 100, via network 110. In general, client device 120 represents one or more programmable electronic devices or combination of programmable electronic devices capable of executing machine readable program instructions and communicating with other computing devices (not shown) within distributed data processing environment 100 via a network, such as network 110. Client device 120 may include components as depicted and described in further detail with respect to FIG. 3, in accordance with embodiments of the present invention.

Client device 120 includes user interface 122, application 124, and sensor 126. In various embodiments of the present invention, a user interface is a program that provides an interface between a user of a device and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API).

Application 124 is a computer program designed to run on client device 120. An application frequently serves to provide a user with similar services accessed on personal computers (e.g., web browser, playing music, teleconferencing, e-mail program, or other media, etc.). In one embodiment, application 124 is mobile application software. For example, mobile application software, or an “app,” is a computer program designed to run on smart phones, tablet computers and other mobile devices. In another embodiment, application 124 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 124 is a client-side application of speech program 200.

Sensor 126 is a device, module, machine, or subsystem whose purpose is to detect events or changes in an operating environment and send the information to other electronics, frequently a computer processor. In various embodiments of the present invention, viewers (e.g., audience members) opt-in and consent to security program 200 collecting and/or processing personal data (e.g., speech of viewers, images of viewers, etc.) of the viewers prior to the personal data being captured by sensor 126. Generally, sensor 126 represents a variety of sensors of client device 120 that collects and provides various kinds of data (e.g., sound, image, motion, video, etc.). In one embodiment, client device 120 transmits data of sensor 126 to server 140 via network 110. For example, sensor 126 can be a camera that client device 120 utilizes to capture and collect images of a plurality of viewers of a user, which are transmitted to a remote server (e.g., server 140). In another example, sensor 126 can be a microphone that client device 120 utilizes to capture audio of a user and/or a plurality of viewers of the user, which is transmitted to a remote server (e.g., server 140).

In various embodiments of the present invention, server 140 may be a desktop computer, a computer server, or any other computer systems, known in the art. In general, server 140 is representative of any electronic device or combination of electronic devices capable of executing computer readable program instructions. Server 140 may include components as depicted and described in further detail with respect to FIG. 3, in accordance with embodiments of the present invention.

Server 140 can be a standalone computing device, a management server, a web server, a mobile computing device, or any other electronic device or computing system capable of receiving, sending, and processing data. In one embodiment, server 140 can represent a server computing system utilizing multiple computers as a server system, such as in a cloud computing environment. In another embodiment, server 140 can be a laptop computer, a tablet computer, a netbook computer, a personal computer (PC), a desktop computer, a personal digital assistant (PDA), a smart phone, or any programmable electronic device capable of communicating with client device 120 and other computing devices (not shown) within distributed data processing environment 100 via network 110. In another embodiment, server 140 represents a computing system utilizing clustered computers and components (e.g., database server computers, application server computers, etc.) that act as a single pool of seamless resources when accessed within distributed data processing environment 100.

Server 140 includes storage device 142, database 144, and speech program 200. Storage device 142 can be implemented with any type of storage device, for example, persistent storage 305, which is capable of storing data that may be accessed and utilized by client device 120 and server 140, such as a database server, a hard disk drive, or a flash memory. In one embodiment storage device 142 can represent multiple storage devices within server 140. In various embodiments of the present invention, storage device 142 stores numerous types of data which may include database 144. Database 144 may represent one or more organized collections of data stored and accessed from server 140. For example, database 144 includes social media data of viewers, publications, audio data of user and viewers, images of viewers, etc. In one embodiment, data processing environment 100 can include additional servers (not shown) that host additional information that accessible via network 110.

Speech program 200 can generate speech recommendations for a user based on data corresponding to a plurality of viewers of the user. In one embodiment, speech program 200 converts audio data of a user to textual data. For example, speech program 200 can utilize natural language processing (NLP) techniques (e.g., optical character recognition (OCR), speech recognition, speech-to-text, tokenization, etc.) to generate a textual representation of speech of a user of audio data. In another embodiment, speech program 200 determines properties of a plurality of viewers of the user. For example, speech program 200 can utilize a machine learning algorithm to identify properties (e.g., audience expectations, knowledge of topic, attitude towards topic, audience size, demographics, setting, etc.) of an audience, which individually consent to (e.g., opt-in) allowing speech program 200 utilize data corresponding to each viewer, of a user. In another embodiment, speech program 200 identifies one or more features of a speech of a user. For example, one or more features may include but is not limited to voice characteristics such as pitch patterns, speech speed, tone, etc. In another embodiment, speech program 200 derives feedback from multimedia data that includes a plurality of viewers of the user. In yet another embodiment, speech program 200 utilizes feedback of a plurality of viewers, textual data of a speech of a user, and one or more features of the speech of the user to rate the speech and generate recommendations for the user.

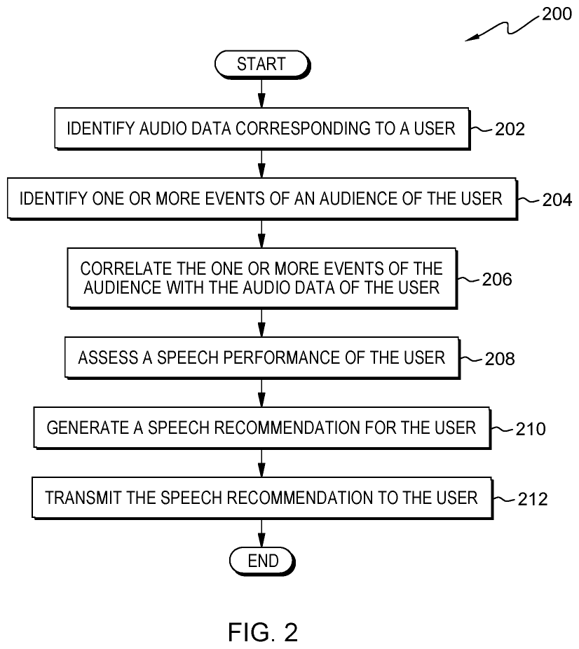

FIG. 2 is a flowchart depicting operational steps of speech program 200, a program that generates speech recommendations for a user based on feedback data corresponding to a plurality of viewers of the user, in accordance with embodiments of the present invention. In one embodiment, speech program 200 initiates in response to a user connecting client device 120 to speech program 200 through network 110. For example, speech program 200 initiates in response to a user registering (e.g., opting-in) a laptop (e.g., client device 120) with speech program 200 via a WLAN (e.g., network 110). In another embodiment, speech program 200 is a background application that continuously monitors client device 120. For example, speech program 200 is a client-side application (e.g., application 124) that initiates upon startup of a teleconferencing application (e.g., application 124) of a laptop (e.g., client device 120) of a user.

In step 202, speech program 200 identifies audio data corresponding to a user. In one embodiment, speech program 200 utilizes sensor 126 of client device 120 to capture audio data of a user and identify speech of the user. For example, speech program 200 utilizes Speech-to-Text (e.g., NLP) to detect speech of a user in audio data captured by a microphone (e.g., sensor 126) of a computing device (e.g., client device 120) of the user. In this example, speech program 200 generates a textual representation of the speech detected in the audio data.

In another example, speech program 200 identifies a user corresponding to detected speech using speech recognition techniques (e.g., voice analysis, speaker recognition, etc.). In this example, speech program 200 verify the identity of the user utilizing a trained algorithm (e.g., neural network, dynamic time warping, Hidden Markov model, etc.) to compare the detected speech of the audio data with samples utilized to train the algorithm. Additionally, speech program 200 utilizes voice analysis to identify characteristics (e.g., pitch patterns, speech speed, tone, etc.) of the detected speech.

In step 204, speech program 200 identifies one or more events of an audience of the user. In one embodiment, speech program 200 identifies one or more events of feedback of a plurality of viewers of audio data of a user. For example, speech program 200 utilizes audio and video data that includes an audience to determine one or more events (e.g., feedback, activity, sentiment, biological state, reaction, etc.) corresponding to each viewer of a user of the audience. In this example, speech program 200 utilizes a machine learning algorithm (e.g., neural network, classifiers, etc.) to identify viewer emotions, complex cognitive states, or activities, etc. using images/video of facial expressions and audio of each viewer.

In another example, speech program 200 predicts one or more events of an audience with respect to speech of a user. In this example, speech program 200 utilizes factorized variational autoencoders (FVAEs) to measure complex audience reactions (e.g., events, taking a nap, confusion, excitement, joy, etc.) by assessing facial expressions of each viewer of the audience and using pattern recognition techniques to determine a sentiment of the audience (i.e., analyzing the surface of faces of audience members and correlating the faces with corresponding sentiments and the segment of the speech transmitted to the audience members).

In another embodiment, speech program 200 determines properties of an audience that includes of one or more viewers of a user. In various embodiments of the present invention viewers of a speech of a user allow (e.g., opt-in, consent, etc.) speech program 200 to collect names, audio, and images of viewers to search social media, publications, addresses, etc. to store, analyze, and determine audience properties, such as but not limited to demographics, expectations, interests of the viewers. For example, speech program 200 utilizes multimedia data of a computing device (e.g., client device 120) to perform an audience analysis to identify audience properties (e.g., expectations, knowledge of topic, attitude toward topic, audience size, demographics, setting, voluntariness, egocentric). In this example, speech program 200 can utilizes various classification algorithms (e.g., neural networks, support vector machines, Naïve Bayes classifier, etc.) used in machine learning to identify audience properties based on images, textual data corresponding to each view. In another embodiment, speech program 200 converts feedback (e.g., audience properties and events) of a plurality of viewers into textual data and correlates the feedback with a segment of a speech a user. In another embodiment, speech program 200 converts feedback (e.g., audience properties and events) of a plurality of viewers into textual data.

In step 206, speech program 200 correlates the one or more events of the audience with the audio data of the user. In another embodiment, speech program 200 correlates one or more events of feedback of a plurality of viewers with a segment of audio data of a user. For example, speech program 200 identifies a reaction (e.g., event) of an audience of a user and determines whether a topic of a segment of a speech of the user corresponds to the reaction of the audience. In this example, speech program 200 utilizes audience properties (e.g., expectations, attitude toward topic, demographics, etc.) to identify a relationship between the reaction of the audience and the topic of speech of the user. In one scenario, speech program 200 utilizes images of facial expressions of an audience of a user to identify a state/event (e.g., confused, engaged, etc.) of the audience while the user delivers a speech. If speech program 200 identifies a state change has occurred (e.g., event, reaction, feedback, etc.), then speech program 200 determines a context of the state change of the audience. For example, the context can include a topic, characteristic of speech, audience attitude toward the topic, etc. In another scenario, speech program 200 generates a corpus of correlated audience properties, topics, speech characteristics, and events.

In step 208, speech program 200 assess a speech performance of the user. In one embodiment, speech program 200 utilizes audio data of a user and feedback of a plurality of viewers to rate a speech a user. For example, speech program 200 inputs a textual representation of one or more segments of a speech of a user into a speech performance model (e.g., machine learning algorithm, artificial neural network) that generates a score for one or more dimensions of essay qualities (e.g., clarity, convincingness, relevance, etc.) of the speech of the user. In this example, speech program 200 generates a score for the speech of the user that corresponds to audience engagement based on feedback of an audience. Speech program 200 utilizes a textual representation of a biological state (e.g., attentive, excited, confused, audience member activities, etc.) of the audience based on audio and/or images of video data of a computing device (e.g., client device 120) that includes state information of each member of the audience to generate a score audience engagement of the speech of the user.

In one scenario, speech program 200 can utilize speech characteristics (e.g., tone, pitch patterns, speed of speech, etc.) of a voice analysis of the user and/or sentence structure of the speech to determine a clarity score of the user. Additionally, speech program 200 can utilize audience properties (e.g., grade level, topic knowledge, etc.) as a factor in determining a clarity or convincingness score of the speech. In another scenario, speech program 200 determines that a majority of an audience of a user are engaged in an activity (e.g., state, event, etc.) such as “talking one another” during a first segment of the speech of the user. Additionally, speech program 200 determines that the majority of the audience of the user are engaged in an activity (e.g., state, event, etc.) such as “applauding the user” during a second segment of the speech of the user. As a result, speech program 200 generates a higher score for the second segment than the first segment as the second segment indicates that the majority of the audience is more engaged with the speech of the user.

In step 210, speech program 200 generates a speech recommendation for the user. In various embodiments of the present invention speech program 200 can train a machine learning algorithm to using audience feedback, textual data of audio of an audience, textual data of audio of a presenter, and voice analysis characteristics (pitch, tone, speed, etc.) of the presenter to identify areas of improvement in the speech delivery of the presenter. Additionally, speech program 200 utilizes the outputs of the machine learning algorithm to provide the presenter speech recommendations in real-time in order to assists the presenter to deliver the speech in real-time.

In one embodiment, speech program 200 provides a speech recommendation to a user of client device 120. For example, speech program 200 utilizes properties of an audience to generate speech recommendations to a user. In this example, speech program 200 can utilize an attitude toward a topic, education level, and cultural norms of demographics (e.g., properties of an audience) of the audience to determine whether use of humor with respect to the topic by a user to increase audience engagement with a speech is offensive. As a result, speech program 200 can generate a textual message that informs the user of a predicted result of the use of humor with respect to the topic prior to delivery to the audience.

In another example, speech program 200 utilizes dimension scores of a user to generate speech recommendations to a user. In this example, speech program 200 utilizes scores of one or more dimensions (e.g., clarity, convincingness, relevance, etc.) of the speech of the user to identify performance areas corresponding to dimension scores of the speech that can be improved (e.g., below a defined threshold value). Additionally, speech program 200 can utilize a goal of the user (e.g., effective teaching, convincing manager, etc.) to correlate with a dimension score to generate a textual message that informs the user of recommendations to improve (i.e., increase dimension score) the speech of the user with respect to the goal.

In one scenario, speech program 200 identifies the clarity dimension as an area of improvement based on a defined threshold and speech program 200 identifies that students of the class have confused facial expressions (e.g., furrow brows, mouth slightly open, extended eye gaze, etc.). Additionally, speech program 200 determines that speech speed (e.g., words per minute) of a user exceeds a rate determined for the class based on grade level (e.g., knowledge about the audience, properties, etc.). As a result, speech program 200 generates a message to the user to decrease speech speed. Furthermore, if speech program 200 identifies that a goal of the user is effective teaching and correlates the confused facial expressions of the students with a topic, then speech program 200 can recommend that the user provide additional examples to explain a concept that corresponds to the topic correlated with the confused facial expressions (e.g., event).

In step 212, speech program 200 transmits the speech recommendation to the user. In one embodiment, speech program 200 transmits a speech recommendation to client device 120. For example, speech program 200 transmits textual data to a computing device (e.g., client device 120) of a user that includes speech recommendations corresponding to one or more dimensions to improve a speech of the user. In an alternative example, the transmitted recommendations correspond to one or more goals of the user. In another embodiment, speech program 200 transmits a speech rating to client device 120. For example, speech program 200 transmits textual data to a computing device of a user that includes scores corresponding to one or more dimensions to improve a speech of the user. In another embodiment, speech program 200 transmits a speech recommendation and speech rating to client device 120. For example, speech program 200 continuously monitors a speech of a user and feedback of an audience to provide the user with scores and speech recommendations of a current segment of a speech of the user.

FIG. 3 depicts a block diagram of components of client device 120 and server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

FIG. 3 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to client device 120, software and data 310 includes data of user interface 122, application 124, and sensor 126. With respect to server 140, software and data 310 includes data of storage device 142 and speech program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, speech of a user in audio data of the user;
identifying, by one or more processors, feedback of one or more audience members of the user associated with the speech of the user;
generating, by one or more processors, an assessment of the speech of the user, wherein the assessment is based at least in part on the feedback of the one or more audience members; and
generating, by one or more processors, a speech recommendation for the speech of the user based at least in part on the assessment of the speech.

2. The method of claim 1, further comprising:
determining, by one or more processors, properties of audience members, wherein the properties of the audience members include classifications based at least in part on collected data corresponding to respective audience members; and
determining, by one or more processors, characteristics of the speech of the user based at least in part on a voice analysis of the audio data.

3. The method of claim 2, further comprising:
predicting, by one or more processors, an event of the feedback of the one or more audience members based on the properties of the audience members.

4. The method of claim 1, further comprising:
correlating, by one or more processors, one or more segments of the speech of the user and one or more events of the feedback based at least in part on a goal of the user; and
providing, by one or more processors, the speech recommendation to the user, wherein the speech recommendation is based at least in part on the goal and a correlated segment of speech and event of the feedback.

5. The method of claim 1, wherein identifying the feedback of the one or more audience members of the user associated with the speech of the user, further comprises:
identifying, by one or more processors, one or more events of the one or more audience members, wherein the one or more events is based at least in part on facial expressions of the one or more audience members; and
determining, by one or more processors, a sentiment of the audience based on the one or more events of the audience members.

6. The method of claim 1, wherein generating the assessment of the speech of the user, further comprises:
converting, by one or more processors, one or more events of the feedback of the one or more audience members to textual data;
identifying, by one or more processors, one or more segments the speech of the user associated with the one or more events and one or more quality dimensions, wherein the one or more quality dimensions are categories included in the assessment of the speech of the user; and
generating, by one or more processors, a score for the one or more quality dimensions based at least in part on the one or more events and the identified one or more segments of the speech of the user.

7. The method of claim 1, wherein generating the speech recommendation for the speech of the user based at least in part on the assessment of the speech, further comprises:
identifying, by one or more processors, a quality dimension with a score below a defined threshold value; and
generating, by one or more processors, textual data that includes a recommendation for the user to perform that corresponds to the quality dimension, wherein performance of the recommendation increases the score of the quality dimension.

8. A computer program product comprising:
one or more computer readable storage media and program instructions stored on the one or more computer readable storage media, the program instructions comprising:
program instructions to identify speech of a user in audio data of the user;
program instructions to identify feedback of one or more audience members of the user associated with the speech of the user;
program instructions to generate an assessment of the speech of the user, wherein the assessment is based at least in part on the feedback of the one or more audience members; and
program instructions to generate a speech recommendation for the speech of the user based at least in part on the assessment of the speech.

9. The computer program product of claim 8, further comprising program instructions, stored on the one or more computer readable storage media, to:
determine properties of audience members, wherein the properties of the audience members include classifications based at least in part on collected data corresponding to respective audience members; and
determine characteristics of the speech of the user based at least in part on a voice analysis of the audio data.

10. The computer program product of claim 9, further comprising program instructions, stored on the one or more computer readable storage media, to:
predict an event of the feedback of the one or more audience members based on the properties of the audience members.

11. The computer program product of claim 8, further comprising program instructions, stored on the one or more computer readable storage media, to:
correlate one or more segments of the speech of the user and one or more events of the feedback based at least in part on a goal of the user; and
provide the speech recommendation to the user, wherein the speech recommendation is based at least in part on the goal and a correlated segment of speech and event of the feedback.

12. The computer program product of claim 8, wherein program instructions to identify the feedback of the one or more audience members of the user associated with the speech of the user, further comprise program instructions to:
identify one or more events of the one or more audience members, wherein the one or more events is based at least in part on facial expressions of the one or more audience members; and
determine a sentiment of the audience based on the one or more events of the audience members.

13. The computer program product of claim 8, wherein program instructions to generate the assessment of the speech of the user, further comprise program instructions to:
convert one or more events of the feedback of the one or more audience members to textual data;
identify one or more segments the speech of the user associated with the one or more events and one or more quality dimensions, wherein the one or more quality dimensions are categories included in the assessment of the speech of the user; and
generate a score for the one or more quality dimensions based at least in part on the one or more events and the identified one or more segments of the speech of the user.

14. The computer program product of claim 8, wherein program instructions to generate the speech recommendation for the speech of the user based at least in part on the assessment of the speech, further comprise program instructions to:
identify a quality dimension with a score below a defined threshold value; and
generate textual data that includes a recommendation for the user to perform that corresponds to the quality dimension, wherein performance of the recommendation increases the score of the quality dimension.

15. A computer system comprising:
one or more computer processors;
one or more computer readable storage media; and
program instructions stored on the computer readable storage media for execution by at least one of the one or more processors, the program instructions comprising:
program instructions to identify speech of a user in audio data of the user;
program instructions to identify feedback of one or more audience members of the user associated with the speech of the user;
program instructions to generate an assessment of the speech of the user, wherein the assessment is based at least in part on the feedback of the one or more audience members; and
program instructions to generate a speech recommendation for the speech of the user based at least in part on the assessment of the speech.

16. The computer system of claim 15, further comprising program instructions, stored on the one or more computer readable storage media for execution by at least one of the one or more processors, to:
determine properties of audience members, wherein the properties of the audience members include classifications based at least in part on collected data corresponding to respective audience members; and
determine characteristics of the speech of the user based at least in part on a voice analysis of the audio data.

17. The computer system of claim 16, further comprising program instructions, stored on the one or more computer readable storage media for execution by at least one of the one or more processors, to:
predict an event of the feedback of the one or more audience members based on the properties of the audience members.

18. The computer system of claim 15, further comprising program instructions, stored on the one or more computer readable storage media for execution by at least one of the one or more processors, to:
correlate one or more segments of the speech of the user and one or more events of the feedback based at least in part on a goal of the user; and
provide the speech recommendation to the user, wherein the speech recommendation is based at least in part on the goal and a correlated segment of speech and event of the feedback.

19. The computer system of claim 15, wherein identify the feedback of the one or more audience members of the user associated with the speech of the user, further comprise program instructions to:
identify one or more events of the one or more audience members, wherein the one or more events is based at least in part on facial expressions of the one or more audience members; and
determine a sentiment of the audience based on the one or more events of the audience members.

20. The computer system of claim 15, wherein generate the assessment of the speech of the user, further comprise program instructions to:
convert one or more events of the feedback of the one or more audience members to textual data;
identify one or more segments the speech of the user associated with the one or more events and one or more quality dimensions, wherein the one or more quality dimensions are categories included in the assessment of the speech of the user; and
generate a score for the one or more quality dimensions based at least in part on the one or more events and the identified one or more segments of the speech of the user.
